(19) United States
(12) Patent Application Publication
(10) Pub. No.: US 2008/0317247 A1
(43) Pub. Date: Dec. 25, 2008

(54) Apparatus and Method for Processing Eap-Aka Authentication in the Non-Usim Terminal

(75) Inventors: Jin-Hwa Jeong, Gyeonggi-do (KR); Sung-Ho Yoo, Seoul (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: POSTDATA CO., LTD, Seongnam-si (KR)

(21) Appl. No.: 12/090,048

(22) PCT Filed: Oct. 13, 2006
(86) PCT No.: PCT/KR2006/004155

§ 371 Date: Apr. 11, 2008

(30) Foreign Application Priority Data
Oct. 14, 2005 (KR) 10-2005-0096995

(51) Int. Cl. H04L 9/08; H04L 9/32

(52) U.S. Cl. 380/44; 713/184

(57) ABSTRACT

Disclosed are an apparatus and a method for processing authentication using Extensible Authentication Protocol-Authentication and Key Agreement (EAP-AKA) in a non-Universal Subscriber Identity Module (USIM) terminal without a USIM card.

According to the present invention, although the USIM card used for user authentication function is absent, the secret value that used to be stored in the USIM card for user authentication is directly stored in the non-USIM terminal. Therefore, both a user password and a secret value are applied for EAP-AKA authentication of the terminal and the user and user authentication problems caused by lack of the USIM card can be overcome.

### TECHNICAL FIELD

The present invention relates to an apparatus and a method for processing authentication in a wireless communication terminal, and more particularly to an apparatus and a method for processing authentication using Extensible Authentication Protocol-Authentication and Key Agreement (EAP-AKA) in a non-Universal Subscriber Identity Module (USIM) terminal without a USIM card.

### BACKGROUND ART

In general, wireless communication terminals used for Advanced Mobile Phone System (AMPS), Code Division Multiple Access (CDMA), Global System for Mobile communication (GSM) and the like are capable of performing communication after authentication process is completed. However the conventional wireless communication terminals only use an Electronic Serial Number (ESN) and a phone number as authentication information, due to absence of substantial authentication process, they may incur lots of security problems.

Recently, in consequence, a variety of authentication mechanisms have been introduced for authentication and security in wireless networks such as Wideband CDMA (WCDMA), Wireless Broadband Internet (WiBro), and Worldwide Interoperability for Microwave Access (WiMAX). A Rivest Shamir Adleman (RSA)-based authentication mechanism and an Extensible Authentication Protocol (EAP)-based authentication mechanism are typical examples. Briefly, the RSA-based authentication mechanism authenticates a terminal using a certificate issued by a manufacturer of the terminal. The EAP-based authentication mechanism authenticates a user using EAP which is a standard protocol for transmitting user authentication data based on Institute of Electrical and Electronics Engineers (IEEE) 802.1x.

The EAP for user authentication applies various authentication mechanisms using a smart card, Kerberos, public key encryption, and One Time Password (OTP) etc. Especially, EAP-Authentication and Key Agreement (EAP-AKA) is based on the smart card such as USIM card.

The EAP-AKA is a technology that applies the AKA mechanism suggested by 3^{rd} Generation Partnership Project (3GPP) to the EAP. More particularly, according to the EAP-AKA, a unique ID and a secret value of a user are stored in a USIM card mounted to a personal wireless communication terminal. Then, authentication-related information used for authentication is generated using the secret value such that the user is authenticated only when the secret value is the same as that of an Authentication, Authorization and Accounting (AAA) server which is connected with the wireless network. Since illegal reading and copying of the information stored in the USIM card are almost unavailable, the EAP-AKA mechanism based on the USIM card can offer reliable authentication and security functions to the terminal user.

While offering very satisfactory security function, however, the above described authentication mechanism using the USIM card is inadequate for a low price wireless communication terminal because the USIM card increases the cost of the terminal. Furthermore, a micro-sized wireless communication terminal cannot adopt the EAP-AKA authentication mechanism since being structurally restricted to mount the USIM card.

### DISCLOSURE OF INVENTION

### Technical Problem

Therefore, the present invention has been made in view of the above-mentioned problems, and it is an object of the present invention to provide an apparatus and a method for processing authentication of a terminal and a user based on Extensible Authentication Protocol-Authentication and Key Agreement (EAP-AKA), even in a non-Universal Subscriber Identity Module (USIM) terminal that a USIM card is not used.

It is another object of the present invention to provide an apparatus and a method for processing EAP-AKA authentication, capable of achieving the same level of security and authentication in a non-USIM terminal at low price and with ease.

It is yet another object of the present invention to provide an apparatus and a method for processing EAP-AKA authentication of a terminal and a user in a non-USIM terminal doubly by using both a user password and a secret value.

### Technical Solution

In order to achieve the above objects of the present invention, there are provided an apparatus and a method for performing authentication using Extensible Authentication Protocol-Authentication and Key Agreement (EAP-AKA) in a non-Universal Subscriber Identity Module (USIM) terminal.

According to an aspect of the present invention, an EAP-AKA authentication apparatus in a non-USIM terminal, comprises key generation means for generating a secret key by adding a special value to a password input by a terminal user to make a predetermined number of bits of the password, and hashing the predetermined number of bits of the password; secret value storage means for storing the secret value encrypted by the secret key; encryption/decryption processing means for encrypting the secret value using the secret key, decrypting the encrypted secret value to obtain the secret value using the secret key and transmitting the secret value; and authentication processing means for receiving the secret value from the encryption/decryption processing means, generating authentication-related information using authentication algorithm based on the secret value, and transmitting the authentication-related information along with a user ID to an authentication server to perform the authentication.

According to an embodiment of the present invention, an EAP-AKA authentication method in a non-USIM terminal, comprises steps of a) generating a secret key by adding a special value to a password input by a terminal user to make a predetermined number of bits of the password, and hashing the predetermined number of bits of the password using a Hash function; b) decrypting an encrypted secret value prestored in the terminal using the secret key to make a secrete value; c) generating authentication-related information by performing authentication algorithm based on the secret value; and d) transmitting the authentication-related information to an authentication server and performing authentication process.

### ADVANTAGEOUS EFFECTS

According to the present invention, authentication of a terminal and a user can be performed based on Extensible Authentication Protocol-Authentication and Key Agreement (EAP-AKA) even in a non-Universal Subscriber Identity Module (USIM) terminal, thereby achieving security effect equivalently to a wireless communication terminal with a USIM card.

Especially, according to the present invention, authentication of a user as well as authentication of a terminal can be performed by using a user password although the USIM card used for user authentication function is absent.

Consequently, security and authentication can be achieved in the non-USIM terminal inexpensively and simply.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a view showing the structure of a wireless communication system;

FIG. 2 is a view explaining communication processes including authentication processes based on Extensible Authentication Protocol-Authentication and Key Agreement (EAP-AKA);

FIG. 3 is a view showing the structure of an EAP-AKA authentication apparatus in a non-Universal Subscriber Identity Module (USIM) terminal, according to an embodiment of the present invention;

FIG. 4 is a flowchart illustrating an EAP-AKA authentication method in a non-USIM terminal, according to an embodiment of the present invention; and

FIG. 5 is a flowchart explaining processes for changing a user password, in the EAP-AKA authentication method in the non-USIM terminal according to the embodiment of the present invention.

### BEST MODE FOR CARRYING OUT THE INVENTION

Hereinafter, an exemplary embodiment of the present invention will be described in detail with reference to the accompanying drawings. Well known functions and constructions are not described in detail since they would obscure the invention in unnecessary detail.

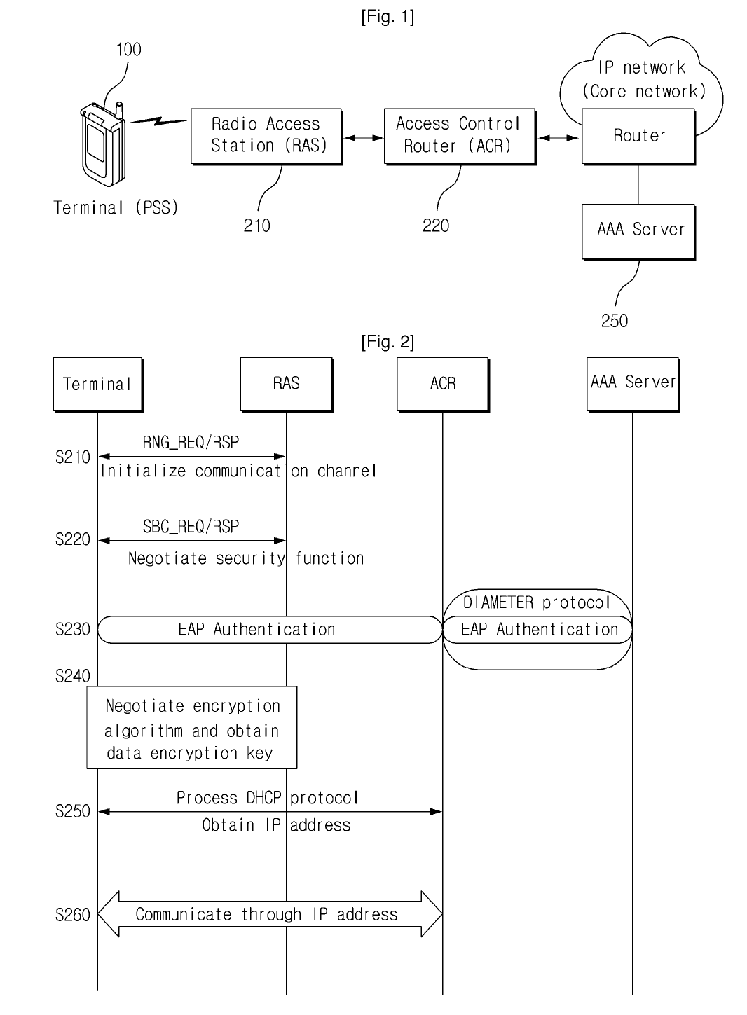

FIG. 1 shows the structure of a general wireless communication system, especially a Wireless Broadband Internet (WiBro) system. As shown in FIG. 1, the WiBro system comprises the terminal (PSS: Portable Subscriber Station) 100, the Radio Access Station (RAS) 210, the Access Control Router (ACR) 220, and the Authentication, Authorization and Accounting (AAA) server 250. The terminal 100 offers portable Internet service to a user. The RAS 210 is a wireless connection device performing reception and transmission at a wired network terminal with another terminal through a wireless interface. The ACR 220 is an access router controlling the terminal and the RAS 210 and routing Internet protocol (IP) packets. The AAA server 250 is an authentication server performing authentication of a user and a terminal, authorization, and of accounting. The ACR 220 and the AAA server 250 are connected through an IP network (core network).

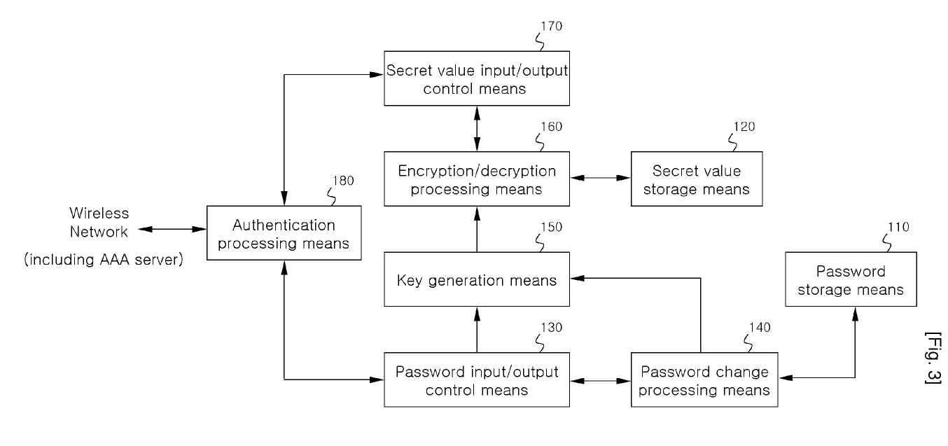

The present invention suggests a technology of performing authentication processes between the terminal 100 and the AAA server 250, in a wireless communication system. The communication processes including the EAP-AKA authentication processes will now be described with reference to FIG. 2.

When a user turns on the terminal 100 to utilize wireless communication service, the terminal 100 transmits a Ranging request (RNG_REQ) message to the RAS 210. Corresponding to this, the RAS 210 transmits a ranging response (RNG_RSP) message to the terminal 100. Thus, information required for the communication is exchanged, thereby system synchronization is acquired and a communication channel is initialized (S210).

The terminal 100 transmits a Subscriber Station Basic Capability-request (SBC_REQ) message to the RAS 210, and the RAS 210 correspondingly transmits a Subscriber Station Basic Capability-response (SBC_RSP) message to the terminal 100. By this, information regarding security capability is negotiated before performing initial authorization process (S220). For instance, more specifically, Privacy Key Management (PKM) version, authentication policies such as RAS, EAP and Authenticated EAP, Message Authentication Code (MAC) mode, Pseudo Noise (PN) window capability of Security Association Identity (SAID) and the like are negotiated in this step S220.

Next, when the terminal 100 tries authentication using the EAP, an EAP authentication information request message sent from the terminal 100 is transmitted to the ACR 220 through the RAS 210. The ACR 220 converts the transmitted message to a DIAMETER protocol message and transmits the converted message to the AAA server 250 (S230). During the step S230, the AAA server 250 may request the terminal user to input a user ID and a user password. When being transmitted, the EAP authentication information request message includes a result value obtained by operating the secret value and the unique user ID for identifying the terminal user. According to this, the terminal 100 transmits authentication-related information required by the AAA server 250, such as the user ID and the result value. The AAA server 250 compares the authentication-related information sent from the terminal 100 with authentication information stored in the AAA server 250 to identify the valid subscriber, and transmits an EAP authentication response message to the terminal 100.

Since a non-USIM terminal is adopted according to the present invention, authentication is performed through authentication algorithm such as security protocol (SP) and EAP-AKA protocol, using the secret value being encrypted and stored in a memory of the terminal. This will be described hereinafter in greater detail.

When the EAP authentication between the terminal 100 and the AAA server 250 is thus ready, encryption algorithm is negotiated for actual communication using a PKM message, and a data encryption key is obtained (S240). The terminal 100 obtains an IP address using Dynamic Host Configuration Protocol (DHCP) (S250). However, this may be omitted in case that the IP address is static. The terminal 100 initiate communication using the obtained IP address, according to a predetermined communication method (S260). For more secure communication, the secret key and authentication-related information update may be performed periodically or as necessitated even during the communication.

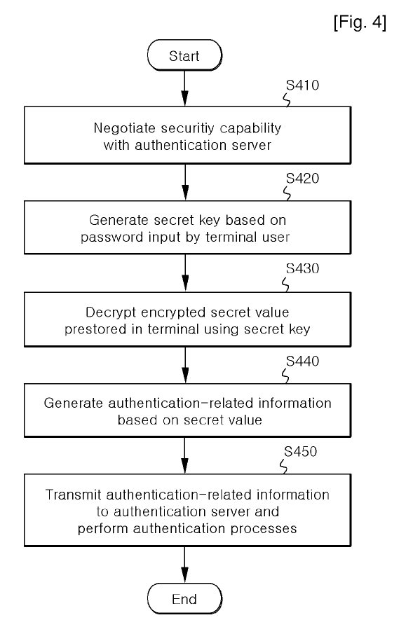

Referring to FIGS. 3 and 4, an apparatus and a method for processing EAP-AKA authentication in the non-USIM terminal according to the present invention will now be described.

FIG. 3 shows the structure of the EAP-AKA authentication apparatus in the non-USIM terminal, according to the exemplary embodiment of the present invention. As shown in FIG. 3, the EAP-AKA authentication apparatus comprises a password storage means 110, a secret value storage means 120, a password input/output control means 130, a password change processing means 140, a key generation means 150, a encryption/decryption processing means 160, a secret value input/output control means 170, and an authentication processing means 180.

The password storage means 110 stores a password set by a user. According to the exemplary embodiment, a hashed password obtained by hashing the password using a Hash function is stored.

The secret value storage means 120 is associated with the encryption/decryption processing means 160 to store an encrypted secret value transmitted from the encryption/decryption processing means 160.

The password input/output control means 130 is input with a password by the user through a predetermined input device, for example, a key board and a password input device, by request of the authentication processing means 180, and transmits the password to the key generation means 150. In addition, when requested by an application to change the password, the password input/output control means 130 is input with a first password and a second password through the predetermined input device, and transmits the input passwords to the password change processing means 140. Here, the first password refers to a existing password before change, and the second password a new password. The first password and the second password can be distinguished from each other, for example, by inputting the first password once while inputting the second password twice.

When requested to change the password, the password change processing means 140 changes the first password prestored in the password storage means 110 into the second password newly transmitted from the password input/output means 130. More specifically, the password change processing means 140 determines whether new passwords consecutively input twice are identical and if so, changes the prestored password into the new password. According to the exemplary embodiment, the password is hashed using a Hash function before being stored. Specifically, in order to convert the first password to a binary of a predetermined number of bits, for example, 128 bits, the password change processing means 140 inserts a second special value to the rest bits, and performs hashing with the first password added with the second special value using a predetermined Hash function such as Message Digest 5 (MD 5) algorithm. (For reference, a first special value will be explained hereinafter in relation to the key generation means 150.) Thus obtained hashed first password is compared to the prestored password already hashed and stored in the password storage means 110. When the first password and the prestored password are matched each other, the second password which is the new password is hashed in the same manner. That is, the second special value is added to the second password to convert the second password to a binary of a predetermined number of bits. The second password added with the second special value is hashed using a predetermined Hash function. The hashed second password is stored in the password storage means 110. Thus, change of password is completed.

The key generation means 150 adds a first special value to the password being transmitted from the password input/output control means 130, thereby converting the password to a binary of a predetermined number of bits, for example, 128 bits. Then, the key generation means 150 generates a secret key by hashing the converted password using a Hash function. The secret key is transmitted to the encryption/decryption processing means 160. In case the password is changed, the key generation means 150 is input with the first and the second passwords from the password change processing means 140, and generates a first secret key and a second secret key by performing addition of the first special value and hashing, respectively. The generated first and the second secret keys are transmitted to the encryption/decryption processing means 160. Although the first special value for adjusting the number of bits in the key generation means 150 may be identical to the second special value used in the password change processing means 140, it is recommended that the first special value and the second special value be differently set for security.

The encryption/decryption processing means 160 reads out the encrypted secret value from the secret value storage means 120, decrypts the encrypted secret value using the secret key transmitted from the key generation means 150, and transmits the decrypted secret value, for example, a code K and an OPc used in a conventional USIM card, to the secret value input/output control means 170. In case the password is changed, the encryption/decryption processing means 160 receives the first secret key which is a current secret key and the second secret key which is a new secret key from the key generation means 150, reads out the encrypted secret value from the secret value storage means 120, decrypts the encrypted secret value by the current secret key to make secret value, encrypts again the secret value by the new secret key, and transmits the encrypted secret value to the secret value storage means 120.

The secret value input/output control means 170 transmits the secret value being transmitted from the encryption/decryption processing means 160, to the authentication processing means 180. The authentication processing means 180 transmits a result value, which is obtained from the secret value transmitted by the secret value input/output control means 170 using authentication algorithm such as the EAP-AKA algorithm, to the AAA server 250 through a wireless network, along with the user ID for identifying each terminal user. The result value may include AT_RAND, AT_AUTN, AT_IV, AT_MAC, AT_RES and so on, and will be referred to as ‘authentication-related information’ hereinafter.

After receiving the authentication-related information and the user ID from the terminal 100, the AAA server 250 detects prestored information corresponding to the user ID and compares the detected information with the authentication-related information. When the terminal user is authenticated, the AAA server 250 performs processes for authenticating the terminal 100.

FIG. 4 is a flowchart illustrating an EAP-AKA authentication method in a non-USIM terminal according to an embodiment of the present invention.

The terminal 100 performs preliminary processes for authentication with the AAA server 250 using a ranging message, an SBC message and the like. Here, the terminal 100 negotiates security capability with the AAA server 250 (S410).

When the preliminary processes for authentication are completed, the authentication processing means 180 of the terminal 100 requests the password input/output control means 130 to be input with the password by the terminal user, to generate information required for authentication. Accordingly, the password input/output control means 130 transmits the password input by the user to the key generation means 150. The key generation means 150 adds the first special value to the input password so that the input password is converted to a 128-bit binary, generates the secret key by hashing the password added with the first special value, and transmits the secret key to the encryption/decryption processing means 160 (S420).

The encryption/decryption processing means 160 reads out the encrypted secret value from the secret value storage means 120, and decrypts the encrypted secret value using the secret key transmitted from the key generation means 150 (S430).

The decrypted secret value such as the code K and the OPc used in the conventional USIM card is transmitted to the authentication processing means 180 through the secret code value input/output control means 170. The authentication processing means 180 operates the decrypted secret code value, thereby generating the authentication-related information such as AT_RAND, AT_AUTN, AT_IV, AT_MAC, and AT_RES (S440).

Next, the authentication processing means 180 transmits the authentication-related information along with the user ID to the AAA server 250 through the wireless network. The AAA server 250 receives the authentication-related information and the user ID from the terminal 100, detects the prestored information corresponding to the user ID, and compares the detected information with the authentication-related information. When the terminal user is a valid user, the AAA server 250 performs processes for authenticating the terminal 100 (S450).

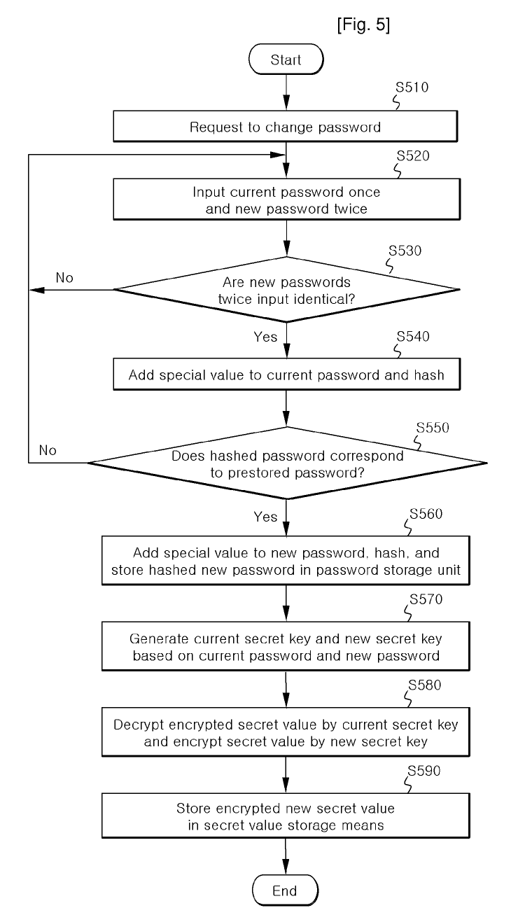

Meanwhile, the secret key for decrypting the encrypted secret value is generated based on the password. According to the embodiment of the present invention, the password can be changed by the following processes described with reference to FIG. 5.

When change of the password is requested by the terminal user (S510), a relevant application in the terminal 100 is driven to perform a series of password changing processes.

When change of the password is requested from the application, the password input/output control means 130 is input with a first password and a second password sequentially through a predetermined input device by the user. The first password refers to a current password before the change and the second password is a new password. Here, the password input/output control means 130 is input with the first password once and then input with the second password twice, and transmits the first and the second passwords to the password change processing means 140 (S520).

The password change processing means 140 compares the two new passwords consecutively transmitted from the password input/output control means 130 to each other, to determine whether the new passwords input twice are identical (S530). When the two new passwords are not matched each other, it is determined that input of the new password is wrongly performed, and the processes are repeated from step S520 for inputting the current password and the new password. When the two new passwords is matched, the password change processing means 140 adds the second special value to the first password, so that the first password generally having 4 bytes or 8 bytes is converted to a predetermined number of bits, for example, 128 bits, and hashes the first password added with the second special value using a predetermined Hash function (S540). Next, the hashed first password is compared to another hashed password stored in the password storage means 110 (S550).

When the hashed first password does not correspond to the prestored password in the password storage means 110, it is determined that input of the current password is wrongly performed, and the processes are repeated from step S520. On the contrary, when the hashed first password corresponds to the stored password in the password storage means 110, the password change processing means 140 changes the first password as the current password into the second password as the new password. For this, the password change processing means 140 adds the second special value to the second password to convert the second password to a binary of a predetermined number of bits, hashes the converted second password using a predetermined Hash function, and stores the hashed second password in the password storage means 110 (S560).

After the password is changed as described above, the processes actually relevant to authentication are performed as follows.

The password change processing means 140 transmits the first and the second passwords to the key generation means 150. The key generation means 150 generates the first and the second secret keys on the basis of the first and the second passwords. More specifically, the key generation means 150 adds the first special value to the first password to adjust the number of bits of the first password, and hashes the first password added with the first special value, thereby generating the first secret key, that is, the current secret key. Likewise, the key generation means 150 adds the second special value to the second password and hashes the second password added with the second special value, thereby generating the second secret key, that is, the new secret key (S570).

The first and the second secret keys generated in the key generation means 150 are transmitted to the encryption/decryption processing means 160. The encryption/decryption processing means 160 reads out the encrypted secret code values from the secret value storage means 120, and decrypts the encrypted secret value using the first secret key, that is, the current secret key. The secret value decrypted by the first secret key is encrypted again using the second secret key, that is, the new secret key. As a result, a new encrypted secret value is generated (S580).

The new encrypted secret value is transmitted to the secret value storage means 120. As the secret value storage means 120 stores the secret value, the existing secret value is changed to the new secret value encrypted based on the new password (S590).

The key generation means 150 transmits the decrypted secret value to the authentication processing means 180 through the secret value input/output control means 170. The authentication processing means 180 generates authentication-related information such as AT_RAND, AT_AUTN, AT_IV, AT_MAC and AT_RES, using authentication algorithm based on the decrypted secret value. The authentication processing means 180 performs authenticating processes by transmitting the authentication-related information along with the user ID to the AAA server 250 through the wireless network.

While the invention has been shown and described with reference to certain embodiments thereof, it will be understood by those skilled in the art that various changes in form and details may be made therein without departing from the spirit and scope of the invention as defined by the appended claims.

1. An Extensible Authentication Protocol-Authentication and Key Agreement (EAP-AKA) authentication apparatus in a non-universal subscriber identity module (USIM) terminal, comprising:
key generation means for generating a secret key by adding a special value to a password input by a terminal user to make a predetermined number of bits of the password, and hashing the predetermined number of bits of the password;
secret value storage means for storing the secret value encrypted by the secret key;
encryption/decryption processing means for encrypting the secret value using the secret key, decrypting the encrypted secret value to obtain the secret value using the secret key and transmitting the secret value; and
authentication processing means for receiving the secret value from the encryption/decryption processing means, generating authentication-related information using authentication algorithm based on the secret value, and transmitting the authentication-related information along with a user ID to an authentication server to perform the authentication.

2. The apparatus of claim 1, further comprising a password input/output control means for being input with a password by the terminal user through a predetermined input device, and transmitting the password to the key generation means.

3. The apparatus of claim 2, further comprising password storage means for storing the password transmitted through the password input/output control means.

4. The apparatus of claim 3, wherein the password stored in the password storage means is hashed by a Hash function.

5. The apparatus of claim 3, further comprising password change processing means for receiving a current password and a new password from the password input/output control means, comparing the current password to a prestored password in the password storage means, and transmitting the new password to the password storage means when the current password and the prestored password are matched.

6. The apparatus of claim 1, further comprising secret value input/output processing means for transmitting to the authentication processing means the secret value being transmitted from the encryption/decryption processing means.

7. The apparatus of claim 1, wherein the predetermined number of bits of the password is 128.

8. An EAP-AKA authentication method in a non-USIM terminal, comprising steps of:
a) generating a secret key by adding a special value to a password input by a terminal user to make a predetermined number of bits of the password, and hashing the predetermined number of bits of the password using a Hash function;
b) decrypting an encrypted secret value prestored in the terminal using the secret key to make a secrete value;
c) generating authentication-related information by performing authentication algorithm based on the secret value; and
d) transmitting the authentication-related information to an authentication server and performing authentication process.

9. The method of claim 8, wherein the predetermined number of bits of the password is 128.

10. The method of claim 8, further comprising, before the step a) negotiating security capability with the authentication server.

11. The method of claim 8, wherein the step d) comprises transmitting a prestored user ID to the authentication server.

12. The method of claim 11, wherein the authentication process includes comparing prestored information corresponding to the user ID with the authentication-related information.

13. The method of claim 8, wherein the step a) comprising steps of:
a1) determining whether the password input by the terminal user corresponds to the password prestored in the non-USIM terminal;
a2) when the input password and the prestored password are matched, changing the password by storing a new password input by the terminal user in the non-USIM terminal; and
a3) generating a first secret key by adding the special value to the password to adjust the number of bits and hashing the password added with the special value using a Hash function.

14. The method of claim 13, wherein the step a3) comprises generating a second secret key by adding the special value to the new password to adjust the number of bits and hashing the new password added with the special value using the Hash function, and
the step b) comprises:
b1) decrypting the encrypted secret value prestored in the terminal using the first secret key to make a secrete value; and
b2) encrypting the secret value using the second secret key, and storing the encrypted secret value in the terminal.

15. The method of claim 13, wherein when the new password is input twice and the new passwords are identical, the password prestored in the non-USIM terminal is changed to the new password.
